(19) United States
(12) Patent Application Publication
(10) Pub. No.: US 2014/0187098 A1
(43) Pub. Date: Jul. 3, 2014

(54) Connector

(71) Applicant: IRISO ELECTRONICS CO. LTD., Kanagawa (JP)

(72) Inventors: Hiroaki Kobayashi, Kanagawa (JP); Hidehiro Shindo, Kanagawa (JP)

(73) Assignee: IRISO ELECTRONICS CO., LTD., Kanagawa (JP)

(21) Appl. No.: 14/108,604

(22) Filed: Dec. 17, 2013

(30) Foreign Application Priority Data
Dec. 28, 2012 (JP) 2012-287179

(51) Int. Cl. H01R 13/533

(52) U.S. Cl. CPC H01R 13/533
USPC 439/660

(57) ABSTRACT

A connector is configured such that elastic deformation of a movable section of each of terminals in the width direction is regulated by a recess within a specific range, thereby preventing the movable section from elastically deforming in the width direction to an excessive extent, even if the movable section of the terminal is subject to the effect of vibration, for example, due to being used in an engine room of a vehicle, and avoiding a short circuit between adjacent terminals or breakage of the terminal in an effective manner.

### BACKGROUND OF THE INVENTION

1. Field of the Invention

The present invention relates to a connector which is mounted, for example, on an in-vehicle substrate and is connected to another substrate or the like.

2. Description of the Related Art

A connector is conventionally known as the above type of connector which includes a fixed housing that is fixed to a substrate, a movable housing that is movable relative to the fixed housing and a plurality of terminals arranged with a space from each other in the width direction, each of the terminals having an elastically deformable movable section between one end and the other end with one end of the terminal fixed to the movable housing and the other end of the terminal fixed to the fixed housing so that elastic deformation of the movable section allows the movable housing to move relative to the fixed housing (for example, see Japanese Unexamined Utility Model Registration Application Publication No. 7-1572).

However, in the case where the connector is mounted on a circuit substrate in an engine room of a vehicle, the connector has a problem in that the movable section of each of the terminals resonates with the vibration caused by rotation of the engine or the like, and especially when resonating at the natural frequency of the movable section, the movable section significantly elastically deforms in the width direction and causes a short circuit between adjacent terminals or breakage of the terminal due to an excessive elastic deformation.

### SUMMARY OF THE INVENTION

Accordingly, it is an object of the present invention to provide a connector in which the movable section of the terminal does not elastically deform in the width direction to an excessive extent, even if the movable section of the terminal is subject to the effect of vibration, for example, due to being used in an engine room of a vehicle.

In order to achieve the above object, the present invention provides a connector which includes a fixed housing that is fixed to a mounting object; a movable housing that is movable relative to the fixed housing; and a plurality of terminals arranged with a space from each other in the width direction, each of the terminals having an elastically deformable movable section between one end and the other end with one end of the terminal fixed to the movable housing and the other end of the terminal fixed to the fixed housing so that elastic deformation of the movable section allows the movable housing to move relative to the fixed housing, wherein a regulation section that regulates elastic deformation of the movable section of each of the terminals in the width direction within a specific range is provided.

Accordingly, even if the movable section of the terminal significantly elastically deforms in the width direction, elastic deformation of the movable section in the width direction is regulated by the regulation section within a specific range. Therefore, the movable section is not excessively elastically deformed by vibration to an excessive extent.

According to the present invention, even if the movable section of the terminal is subject to the effect of vibration, for example, due to being used in an engine room of a vehicle, the movable section does not elastically deform in the width direction to an excessive extent. Accordingly, it is possible to prevent a short circuit between adjacent terminals or breakage of the terminal in an effective manner.

### BRIEF DESCRIPTION OF THE DRAWINGS

FIG. 1 is a front perspective view of a connector according to one embodiment of the invention.

FIG. 2 is a rear perspective view of the connector.

FIG. 3 is a front elevation view of the connector.

FIG. 4 is a rear elevation view of the connector.

FIG. 5 is a plan view of the connector.

FIG. 6 is a bottom view of the connector.

FIG. 7 is a side view of the connector.

FIG. 8 is a partial sectional perspective view of the connector.

FIG. 9 is a side sectional view of the connector.

FIG. 10 is a front sectional view of the connector.

FIG. 11 is a perspective view of the terminal.

FIG. 12 is a front sectional view of an essential part of the connector.

### DESCRIPTION OF THE PREFERRED EMBODIMENTS

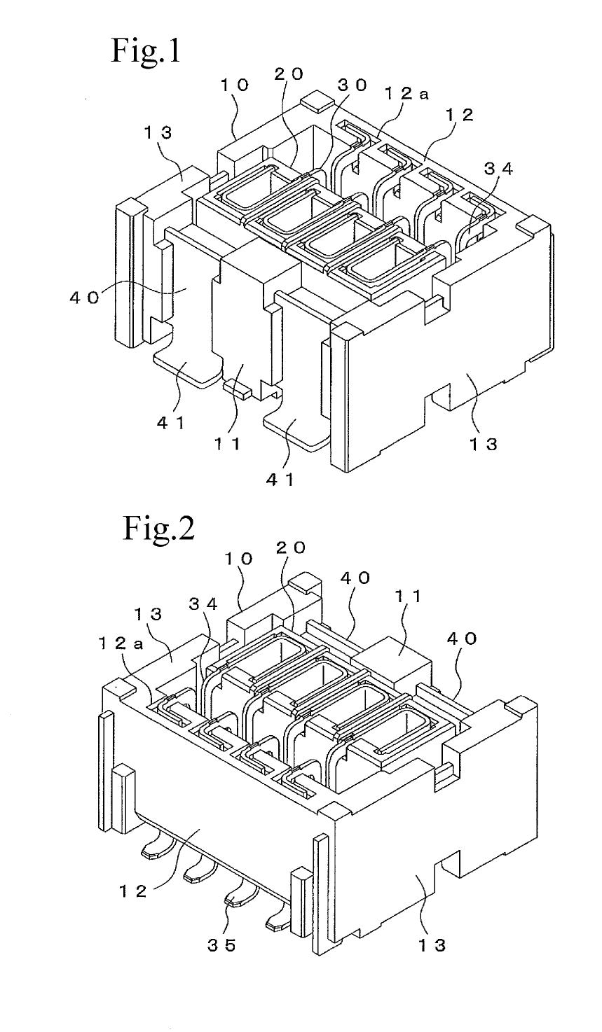

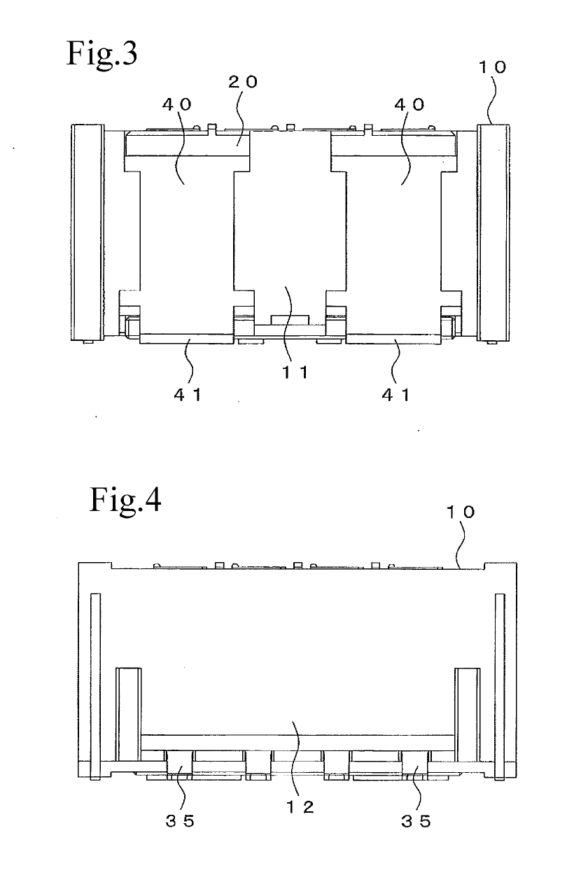

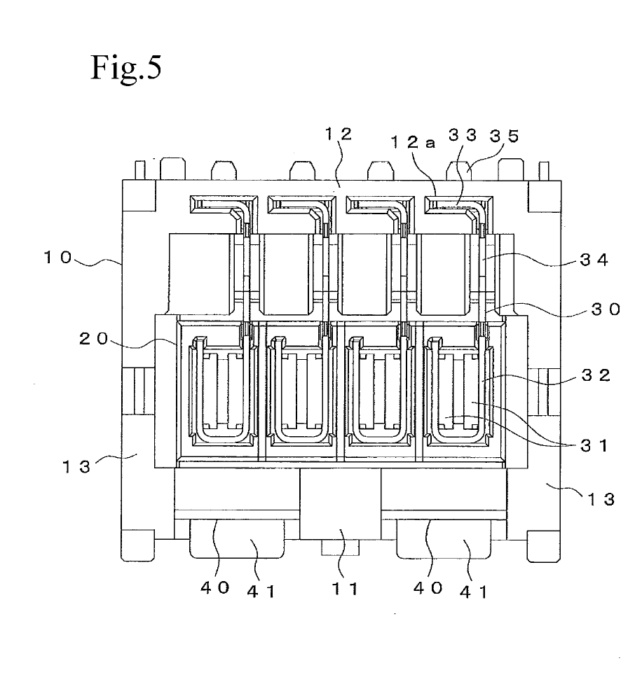

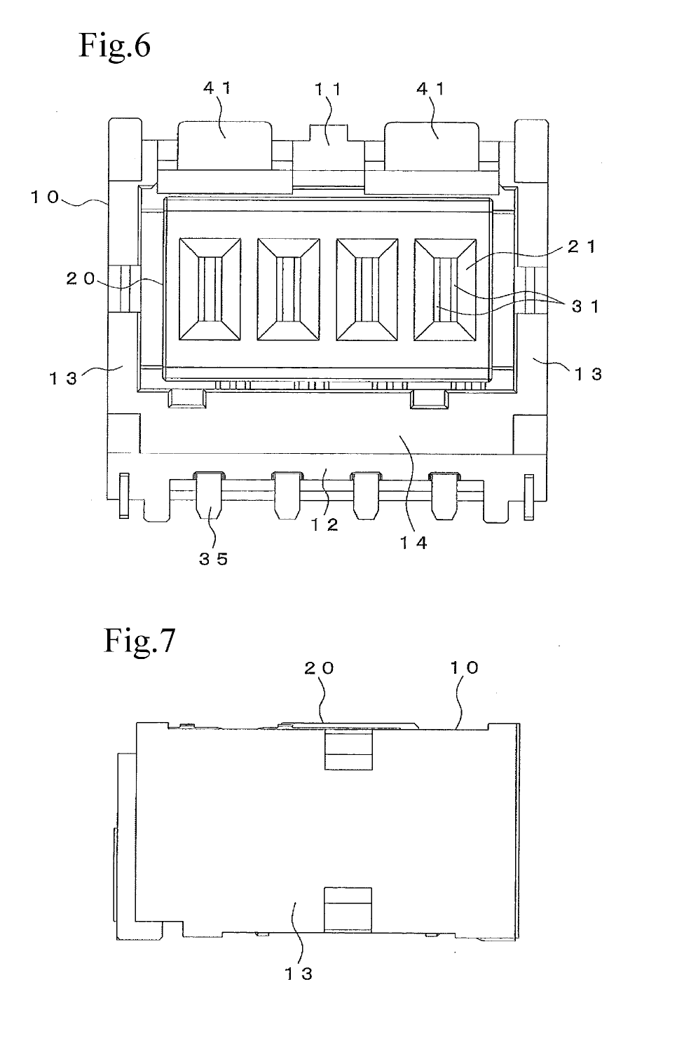

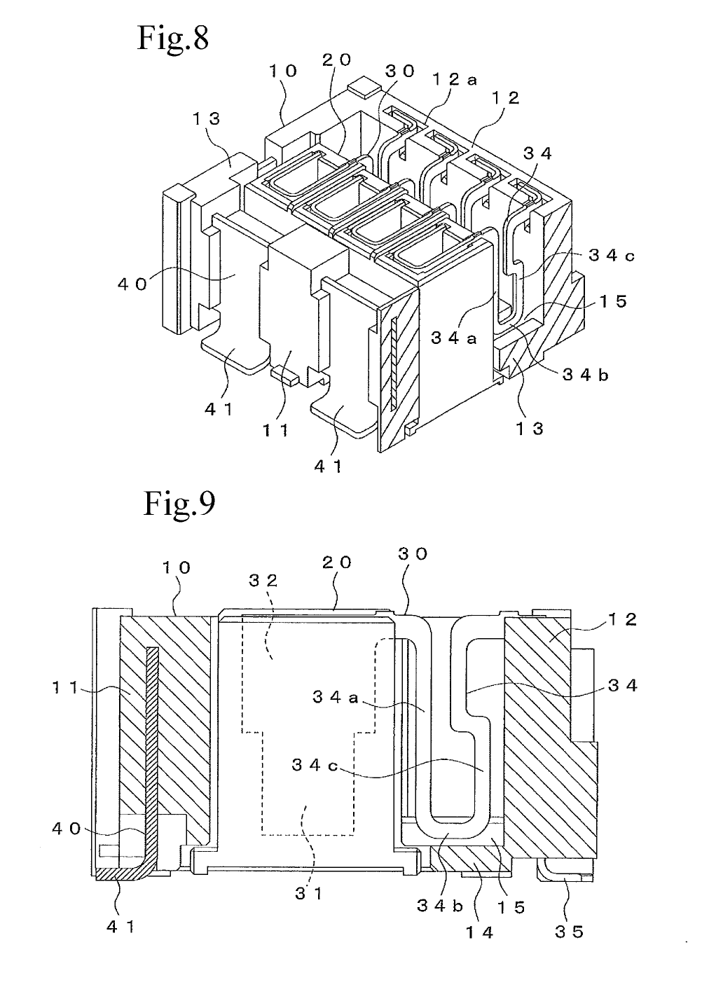

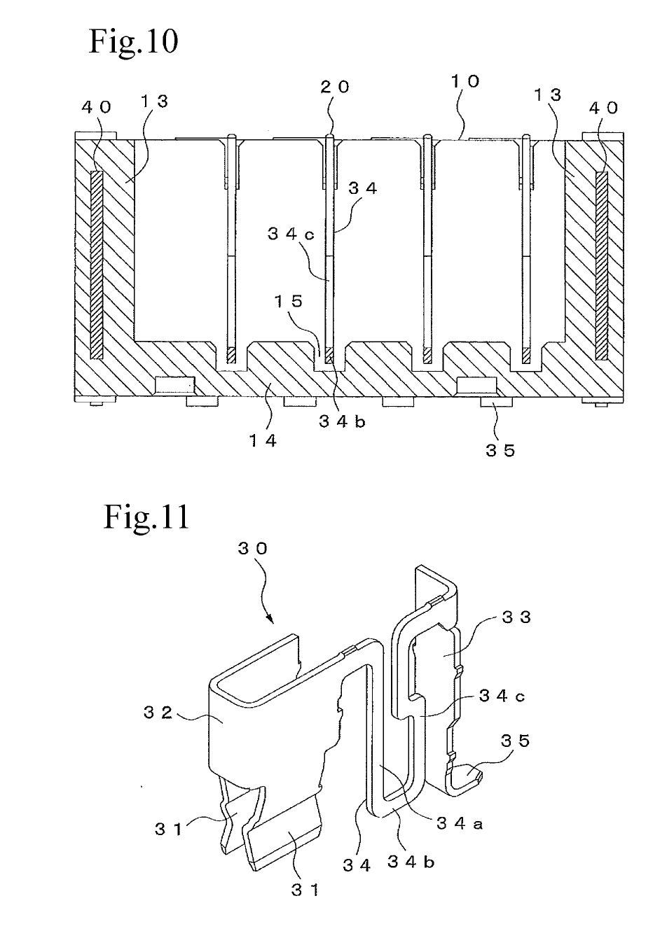

FIGS. 1 to 12 show a connector according to one embodiment of the invention which is mounted, for example, on an in-vehicle substrate.

The connector includes a fixed housing 10 that is mounted on a substrate, which is not shown in the figure, a movable housing 20 that is movable relative to the fixed housing 10, a plurality of terminals 30 arranged with a space from each other in a width direction and a pair of fixed members 40 that is fixed to the substrate.

The fixed housing 10 is a molding of a synthetic resin and is formed in a substantially cuboid shape having a height dimension smaller than a front-back dimension and a width dimension. The fixed housing 10 includes a front face 11, a back face 12 and right and left side faces 13. Further, a plurality of fixed holes 12a for fixing the respective terminals 30 is disposed on the back face 12. Portions of the top and bottom faces of the fixed housing 10 are open upward and downward, respectively, and the remaining portion of the bottom face has a bottom section 14. Further, a plurality of recesses 15 is disposed on the bottom section 14 as regulation sections that regulate elastic deformation of the respective terminals 30 in the width direction within a specific range.

The movable housing 20 is a molding of a synthetic resin and is formed in a substantially cuboid shape having a height dimension larger than a width dimension and a depth dimension. The movable housing 20 is formed in a hollow shape with the top and bottom faces being open, and is disposed in the fixed housing 10 so as to be movable in the front-back direction, the width direction and the up-down direction. The movable housing 20 is disposed in the fixed housing 10 at a position which is open upward and downward, and a space is formed above the bottom section 14 between the back face of the movable housing 20 and the back face 12 of the fixed housing 10. Insertion ports 21 through which counterpart terminals, which are not shown in the figure, are inserted are disposed on the bottom face of the movable housing 20. The insertion ports 21 are formed in a tapered shape which increases in size downward.

The terminals 30 are made of a conductive metal and have one end fixed to the movable housing 20 and the other end fixed to the fixed housing 10. Each terminal 30 includes a pair of contact pieces 31 that contacts a counterpart terminal, which is not shown in the figure, a first fixed section 32 that is fixed to the movable housing 20, a second fixed section 33 that is fixed to the fixed housing 10, an elastically deformable movable section 34 that is disposed between the first fixed section 32 and the second fixed section 33, and a substrate connection section 35 that is connected to the substrate.

The contact pieces 31 oppose each other with a space therebetween in the width direction of the terminal 30 and bends toward each other at the center portion in the up-down direction. The first fixed section 32 is formed in a substantially U-shape which curves along the inner surfaces of the front face and the side faces of the movable housing 20 and is fixed in the movable housing 20 when being press-fit in the upper portion of the movable housing 20. Each of the contact pieces 31 extends downward from each side face of the first fixed section 32 such that the contact pieces 31 and the first fixed section 32 are both positioned in the movable housing 20. The second fixed section 33 is in a plate shape which extends in the up-down direction and is fixed in the fixed housing 10 when being press-fit in the fixed hole 12a of the fixed housing 10.

The movable section 34 extends downward from one end of the terminal 30 and curves in the opposite direction to the other end of the terminal 30. That is, the movable section 34 includes a first movable piece 34a that extends downward from the upper end of the first fixed section 32 along the back face of the movable housing 20 into the recess 15 of the bottom section 14, a second movable piece 34b that extends backward from the lower end of the first movable piece 34a inside the recess 15, and a third movable piece 34c that extends upward from the back end of the second movable piece 34b along the inner surface of the back face 12 to the upper end of the second fixed section 33, and the second movable piece 34b forms the curved portion.

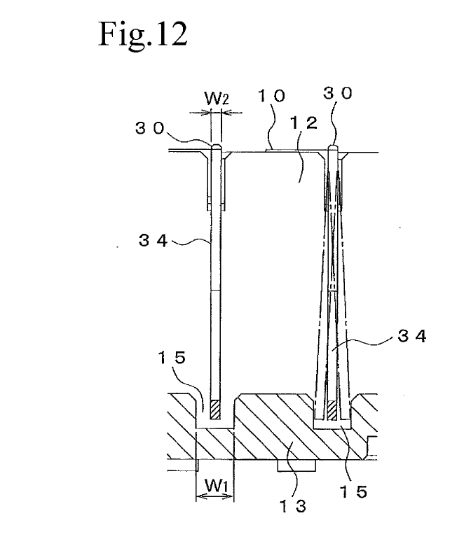

As shown in FIG. 12, the recess 15 has a width W1 which is larger than a width W2 of the movable section 34. When the movable section 34 elastically deforms in the width direction in the recess 15, the second movable piece 34b of the movable section 34 abuts against the inner surface of the recess 15 so that elastic deformation of the movable section 34 is regulated by the recess 15 within the range of the width W1. The substrate connection section 35 extends backward from the lower end of the second fixed section 33 and is soldered to the substrate, which is not shown in the figure.

The fixed members 40 are formed by bending a metal plate and disposed on the front face of the fixed housing 10 on each side in the width direction. Each fixed member 40 is integrally formed with the front face 11 of the fixed housing 10 by insert molding and has a fixed piece 41 at the lower end which is soldered to the substrate.

The connector having the above configuration is mounted, for example, on a substrate in an engine room of a vehicle by soldering the substrate connection section 35 of the terminal 30 and the fixed piece 41 of the fixed member 40 to the substrate, which is not shown in the figure. In this case, the substrate has a plurality of through-holes that allow the counterpart terminals which are, for example, formed of pin terminals to be inserted. The respective through-holes are disposed under the insertion ports 21 of the movable housing 20. That is, when the counterpart terminal is inserted into the through-hole from the lower side of the substrate, the counterpart terminal is inserted into the insertion port 21 of the movable housing 20 and is press-fit between the contact pieces 31 of the terminal 30, thereby allowing the counterpart terminal to be connected to the terminal 30.

When the counterpart terminal is displaced with respect to the substrate during the connection state due to vibration caused by rotation of the engine or the like, elastic deformation of the movable section 34 of the terminal 30 allows the movable housing 20 to move in the front-back direction, the width direction or the up-down direction relative to the fixed housing 10, thereby absorbing displacement of the counterpart terminal relative to the substrate. During the deformation, even if the movable section 34 resonates with the vibration caused by rotation of the engine or the like and significantly elastically deforms in the width direction, elastic deformation of the movable section 34 in the width direction is regulated by the recess 15 within the range of the width W1. Therefore, the movable section 34 is not elastically deformed by vibration to an excessive extent.

As described above, according to the above embodiment, the elastic deformation of the movable section 34 of the terminal 30 in the width direction is regulated by the recess 15 within a specific range W1. Therefore, even if the movable section 34 is subject to the effect of vibration, the movable section 34 does not elastically deform in the width direction to an excessive extent, and accordingly, a short circuit between adjacent terminals 30 or breakage of the terminal 30 can be prevented in an effective manner.

In this case, the movable section 34 of the terminal 30 is formed to extend downward from one end of the terminal 30 and curve in the opposite direction to the other end of the terminal 30, and the movement of the curved portion (second movable piece 34b) of the movable section 34 in the width direction is regulated by the recess 15 within the specific range W1. Accordingly, it is possible that the recess 15 certainly regulates an excessive elastic deformation of the curved portion in which the largest displacement occurs in the terminal 30. This is highly advantageous in preventing a short circuit or breakage of the terminal 30.

Further, the regulation section that regulates elastic deformation of the movable section 34 of each of the terminals 30 in the width direction within the specific range W1 is provided as the recess 15 which is formed on the bottom section 14 of the fixed housing 10. Accordingly, the recess 15 can be easily formed and simplified in configuration.

Although the regulation section in the above embodiment is described as being provided as the recess 15, the regulation section may be in a form other than a recess, and may be in a form such as a projection and a wall.

What is claimed is:

1. A connector comprising:
a fixed housing that is fixed to a mounting object;
a movable housing that is movable relative to the fixed housing; and
a plurality of terminals arranged with a space from each other in a width direction, each of the terminals having an elastically deformable movable section between one end and the other end with one end of the terminal fixed to the movable housing and the other end of the terminal fixed to the fixed housing so that elastic deformation of the movable section allows the movable housing to move relative to the fixed housing, wherein a regulation section that regulates elastic deformation of the movable section of each of the terminals in the width direction within a specific range is provided.

2. The connector according to claim 1, wherein the movable section of each of the terminals is formed to extend from one end of the terminal in a specific direction and curve in the opposite direction to the other end of the terminal, and the regulation section is formed to regulate movement of the curved portion of the movable section in the width direction within a specific range.

3. The connector according to claim 1, wherein the regulation section is formed by a recess which is disposed on the fixed housing.

4. The connector according to claim 2, wherein the regulation section is formed by a recess which is disposed on the fixed housing.
